(19) United States
(12) Patent Application Publication
(10) Pub. No.: US 2021/0073968 A1
(43) Pub. Date: Mar. 11, 2021

(54) System and method for detecting whether solder joints are bridged using deep learning model

(71) Applicants: Inventec (Pudong) Technology Corporation, Shanghai (CN); INVENTEC CORPORATION, Taipei (TW)

(72) Inventor: Hao LIU, Shanghai (CN)

(73) Assignees: Inventec (Pudong) Technology Corporation, Shanghai (CN); INVENTEC CORPORATION, Taipei (TW)

(21) Appl. No.: 17/013,657

(22) Filed: Sep. 7, 2020

(30) Foreign Application Priority Data
Sep. 9, 2019 (CN) 2019108479182

(51) Int. Cl. G06T 7/00; G06T 7/73; G06N 20/00

(52) U.S. Cl. CPC G06T 7/001; G06T 7/74; G06T 2207/20081; G06N 20/00; G06T 2207/30152; G06T 7/97

(57) ABSTRACT

The present disclosure relates to a system and method for detecting whether solder joints are bridged by using a deep learning model. After an SPI device generates a detection result of a pad, the present disclosure analyzes a detection image corresponding to the solder joint with poor soldering indicated by a detection result by using a detection model. When there is a bridge in the detection image, the detection image is displayed to provide a re-judgment technique, thereby achieving the technical effect of reducing the number of solder joints which are misjudged to be bridged and shortening the time required for manual re-judgment.

### CROSS REFERENCE TO RELATED APPLICATION

The present application is related to and claims the benefit of priority to Chinese Patent Application No. 201910847918.2, entitled “System and Method for Detecting Whether Solder Joints are Bridged Using Deep Learning Model”, filed with SIPO on Sep. 9, 2019, the contents of which are incorporated herein by reference in its entirety.

### BACKGROUND

### Field of Disclosure

The present disclosure relates to a system and method for detecting solder joint bridge, and in particular, to a system and method for detecting whether solder joints are bridged using a deep learning model.

### Description of Related Arts

Solder Paste Inspection (SPI) devices can calculate the height of solder paste on a Printed Circuit Board (PCB) by using optical principles. The SPI devices can detect five index data, such as the volume, area, height, X offset, and Y offset of each solder joint, and use the detected index data to determine whether the solder joint is defective.

Although most of the poor soldering conditions can be determined by the index data detected by the SPI devices, the bridge condition cannot be effectively determined using only the five index data detected by the SPI devices. As a result, the SPI devices often misjudge the solder joints without bridging as being bridged, which unnecessarily increases the workload of the person performing checking.

In summary, it can be known that there has always been a problem of misjudgment of bridges in the detection results of the SPI devices, so it is necessary to propose an improved technical means to solve this problem.

### SUMMARY

In view of the problem that bridges are often misjudged in the detection results of the SPI devices, the present disclosure provides a system and method for detecting whether solder joints are bridged using a deep learning model.

The system for detecting whether solder joints are bridged using a deep learning model described in the present disclosure includes at least: a model building module for building a detection model; a result obtaining module, obtaining a detection result generated by an SPI device detecting a pad, the pad includes a plurality of solder joints, the detection result includes a detection image corresponding to the solder joint indicating poor soldering; an image analysis module, analyzing the detection image corresponding to the solder joint with poor soldering by using the detection model, and generating an analysis result; an output module, displaying the detection image when the analysis result indicates that a bridge is contained in the detection image.

The method for detecting whether solder joints are bridged using a deep learning model described in the present disclosure includes at least: building a detection model; providing a pad, the pad contains a plurality of solder joints; obtaining a detection result generated by an SPI device for detecting the pad, and the detection result includes a detection image corresponding to the solder joint with poor soldering; analyzing the detection image corresponding to the solder joint with poor soldering by using the detection model, and generating an analysis result; displaying the detection image when the analysis result indicates that a bridge is contained in the detection image.

The present disclosure differs from the prior art in that, after the SPI device generates a detection result of the pad, the present disclosure analyzes the detection image corresponding to the solder joint with poor soldering indicated by the detection result by using the detection model. When there is a bridge in the detection image, the detection image is displayed for re-judgment, thereby solving the problems existing in the prior art, and achieving the technical effect of reducing the number of solder joints for manual re-judgment to shorten the time required for manual re-judgment.

### BRIEF DESCRIPTION OF THE DRAWINGS

FIG. 1 is a schematic view of a system for detecting whether solder joints are bridged using a deep learning model according to the present disclosure.

FIG. 2A is a flowchart of a method for detecting whether solder joints are bridged using a deep learning model according to the present disclosure.

FIG. 2B is a flowchart of an additional method for adjusting a deep learning model according to the present disclosure.

### DESCRIPTION OF COMPONENT MARK NUMBERS

100 Computing device
110 Model building module
120 Result obtaining module
130 Image analysis module
140 Output module
150 Setting module
400 Solder Paste Inspection (SPI) device

### DETAILED DESCRIPTION OF THE PREFERRED EMBODIMENTS

The features and embodiments of the present disclosure will be described in detail below with reference to the drawings and embodiments. The content is sufficient for anyone skilled in the art to easily and fully understand the technical means applied to solve the technical problems of the present disclosure and implement them accordingly, thereby achieving the effect that can be achieved by the present disclosure.

The present disclosure can further detect solder joints with poor soldering detected by the Solder Paste Inspection (SPI) devices, thereby reducing the misjudgment of bridges by the SPI devices. The bridge mentioned in the present disclosure refers to a situation in which two or more solder joints are connected through a solder paste, resulting in a printed circuit board not functioning normally.

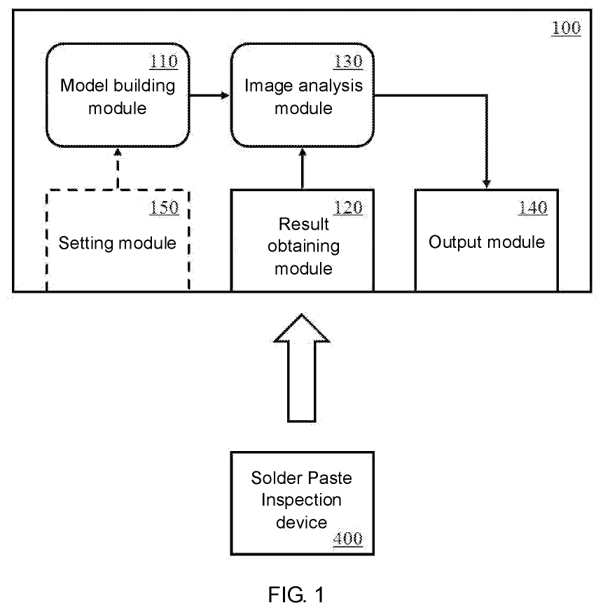

The system operation of the present disclosure will be described as follows with FIG. 1. FIG. 1 is a schematic view of a system for detecting whether solder joints are bridged using a deep learning model according to the present disclosure. As shown in FIG. 1, the system of the present disclosure includes a model building module 110, a result obtaining module 120, an image analysis module 130, an output module 140, and an additional setting module 150. The system of the present disclosure can be applied to a computing device 100.

The model building module 110 is responsible for building a detection model. In the present disclosure, the model building module 110 establishes the detection model by training a deep learning algorithm capable of recognizing image with a sufficient number of images. The images used by the model building module 110 to build the detection model include multiple images around a certain solder joint that is bridged with other solder joints, and also include multiple images around a certain solder joint where no bridging occurs.

Generally speaking, the deep learning algorithm used by the model building module 110 to build a detection model may be a faster region-convolutional neural network (Faster R-CNN) algorithm, but the present disclosure is not limited thereto. For example, it may be a Fast RCNN, you only look once (YOLO), or other algorithms.

The result obtaining module 120 is responsible for obtaining a detection result generated by the SPI device 400 for detecting the land/pad. Generally speaking, the pads detected by the SPI device 400 include a plurality of solder joints. The SPI device 400 can detect the volume, area, height, X offset and Y offset of each solder joint in the existing manner, and determine whether the solder joint is poorly soldered according to the index data obtained after each solder joint is detected. When the solder joint is determined to be poor, the SPI device 400 can obtain an image of a certain range around the solder joint that is poorly soldered as a detection image corresponding to the solder joint that is poorly soldered, and adds the obtained image to the detection result.

The detection results obtained by the result obtaining module 120 may include information about whether solder joints on the detected pads are poorly soldered, or may include only relevant information indicating each solder joint that is poorly soldered. The above-mentioned relevant information of the solder joint includes, but is not limited to, position information of the solder joint, whether the solder joint is poorly soldered, and a detection image corresponding to the solder joint. The position information of the solder joint can indicate data or information of the position of the solder joint on the pad. The data or information includes but is not limited to the coordinates, number, or identification data of the solder joint on the pad.

The result obtaining module 120 continuously monitors a target directory. And when a file recording the detection result is added to the target directory, the result obtaining module reads the detection result from the file. The result obtaining module 120 may also provide the user to select a file in the target directory and read the detection result from the selected file. The above-mentioned target directory may be in the computing device 100 or on other devices, which is not limited by the present disclosure. When the target directory is on other devices, the result obtaining module 120 may be connected with other devices through a wired or wireless network to monitor the target directory. However, the manner in which the result obtaining module 120 obtains the detection result is not limited to the above.

The image analysis module 130 analyzes the detection image included in the detection result obtained by the result obtaining module 120 using the detection model built by the model building module 110, and the corresponding analysis result is generated by the detection model. The image analysis module 130 may provide the detection image obtained by the result obtaining module 120 as input data to the detection model, so that the detection model analyzes the input detection model and outputs a corresponding analysis result. The analysis result generated by the detection model can indicate whether there is a bridge in the detection image. Generally speaking, the detection model can indicate whether there is a bridge in the detection image by a text description or a symbol in the analysis result. In some embodiments, the image analysis module 130 may add all or part of the relevant information of the solder joints included in the detection image to the analysis result when the analysis result indicates that there is a bridge in the detection image; or always add all or part of the relevant information of the solder joints included in the detection image to the analysis results.

The output module 140 displays a detection image indicating that there is a bridge when the analysis result generated by the image analysis module 130 indicates that there is a bridge in the detection image, so that the user can determine whether the solder joints in the displayed detection image are actually bridged according to the detection image displayed by the output module 140.

In some embodiments, the output module 140 may output the position information corresponding to the bridged solder joints, such as the coordinates or numbers of the bridged solder joints on the pad or printed circuit board, according to the detection result obtained by the result obtaining module 120 or relevant information of the solder joint in the analysis result generated by the image analysis module 130, but the present disclosure is not limited to this.

The setting module 150 may set confirmation data corresponding to the detection image displayed by the output module 140. The confirmation data set by the setting module 150 can indicate whether a bridge exists in the detection image. Generally, the setting module 150 can provide the user a user interface to set the confirmation data based on the operation.

The setting module 150 may provide the set confirmation data and the corresponding detection image to the model building module 110, so that the model building module 110 can further train the detection model according to the confirmation data set by the setting module 150 and the corresponding detection image, so as to make the determination of the detection model more accurate.

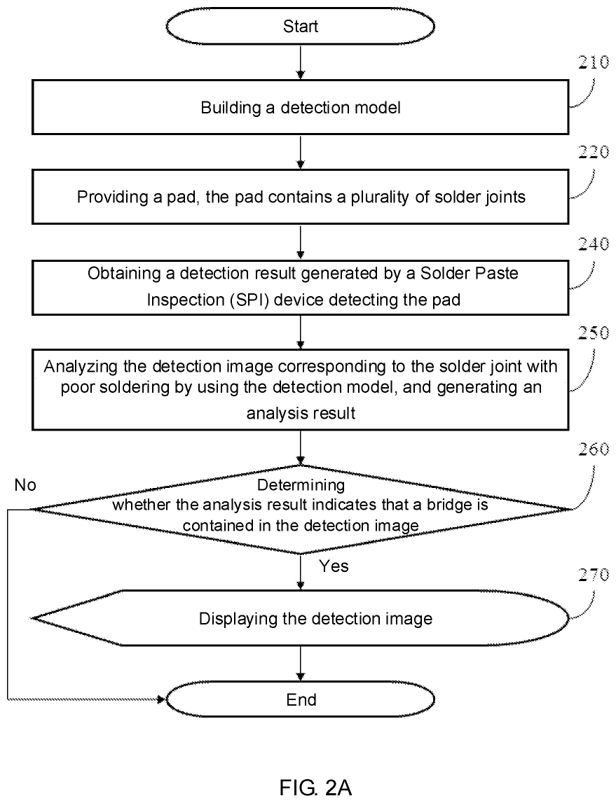

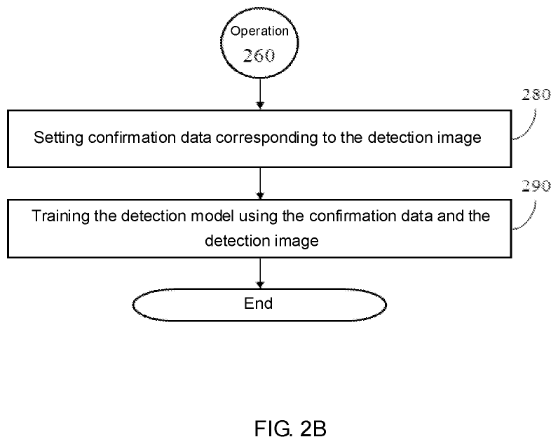

An embodiment is used to explain the operating system and method of the present disclosure. Referring to the flowchart of a method for detecting whether solder joints are bridged using a deep learning model according to the present disclosure, as shown in FIG. 2A.

When the user wants to use the present disclosure, the model building module 110 may first build a detection model (operation 210). In this embodiment, assuming that the model building module 110 uses a Faster R-CNN algorithm, the user can use the image of the area surrounding the solder joint detected on the printed circuit board in the past as input, and train the Faster R-CNN algorithm used by the model building module 110 to generate the detection model.

After the model building module 110 builds a detection model (operation 210), the result obtaining module 120 can obtain a detection result generated by the SPI device 400 detecting the pad (operation 240). In this embodiment, if the present disclosure is applied to a server where the SPI device 400 stores the detection result, the result obtaining module 120 can directly monitor the directory (that is, the target directory proposed by the present disclosure) where the SPI device 400 stores the detection result. And when a new file is generated in the directory, the detection result is read from the generated new file. If the present disclosure is applied to a client end connected with the server that stores the detection result of the SPI device 400, the result obtaining module 120 can connect to the server through the network, and monitor the target directory. And when a new file is generated in the target directory, the detection result is read from the generated new file.

It should be noted that, in general, the model building module 110 may first build a detection model (operation 210), then the user may provide a pad including a plurality of solder joints (operation 220), and detect the pad to generate a detection result by using the SPI device 400, so that the result obtaining module 120 can obtain the detection result (operation 240). But in practice, the present disclosure does not have such a limitation. That is, the user may provide the pad first (operation 220), then detect the pad to generate a detection result by using the SPI device 400, so that the result obtaining module 120 can obtain the detection result first (operation 240), then the model building module 110 builds the detection model (operation 210).

After the model building module 110 builds the detection model (operation 210) and the result obtaining module 120 obtains the detection result (operation 240), the image analysis module 130 may use the detection model built by the model building module 110 to analyze the detection image obtained by the result obtaining module 120, and generate the corresponding analysis result (operation 250). In this embodiment, it is assumed that the detection result generated by the SPI device 400 includes only the position information of the solder joint that is determined to be poor soldering and an image (that is, the detection image proposed by the present disclosure) from a certain range around the solder joint. The image analysis module 130 may provide the detection image included in the detection result as an input to the detection model, so that the detection model analyzes the detection image and outputs the analysis result.

After the image analysis module 130 generates the analysis result of the detection image (operation 250), the image analysis module 130 may determine whether the analysis result indicates that the detection image includes a bridge (operation 260). If not, the present disclosure can skip the detection image judged as not including the bridge. If the analysis result indicates that the detection image includes a bridge, the display module 140 may display a detection image indicating that a bridge is included (operation 270), so that the user determines whether a bridge really exists in the detection image according to the displayed detection image.

In this way, with the present disclosure, the probability of solder joints being misjudged as bridging can be reduced, and the number of re-judgments by users can be reduced.

In the above embodiment, if the computing device 100 further includes a setting module 150, as shown in the flowchart of FIG. 2B, after the display module 140 displays a detection image indicating that a bridge is included (operation 270), the setting module 150 may set confirmation data corresponding to the detection image displayed by the display module 140 (operation 280). For example, the setting module 150 may provide the user to select whether a bridge exists, and may generate corresponding confirmation data according to the user's selection.

After the setting module 150 sets the confirmation data corresponding to the detection image (operation 280), the set confirmation data and the detection image corresponding to the confirmation data may be provided to the model building module 110, so that the model building module 110 uses the confirmation data and the corresponding detection image to train the detection model (operation 290).

In summary, it can be seen that the present disclosure differs from the prior art in that, after the SPI device generates a detection result of the pad, the present disclosure analyzes the detection image corresponding to the solder joint with poor soldering indicated by the detection result by using the detection model. When there is a bridge in the detection image, the detection image is displayed to provide a re-judgment technique. By this technique, the problem of misjudgment of the bridge in the detection results of the existing SPI devices can be solved, thereby achieving the technical effect of reducing the number of solder joints for manual re-judgment to shorten the time required for manual re-judgment.

Furthermore, the method for detecting whether solder joints are bridged using a deep learning model of the present disclosure can be implemented in hardware, software, or a combination of hardware and software, and can also be implemented in a computer system in a centralized manner or in a decentralized manner in which different components are spread across several interconnected computer systems.

Although the embodiments of the present disclosure have been described above, the description is not intended to limit the scope of the present disclosure. Any person skilled in the art to which the present disclosure belongs can make some modifications in the form and details of the implementation without departing from the spirit and scope of the present disclosure. Therefore, the scope of patent protection of the present disclosure shall be subject to scope defined in the attached claims.

We claim:

1. A method for detecting whether solder joints are bridged using a deep learning model, comprising at least:
building a detection model;
providing a pad, the pad contains a plurality of solder joints;
obtaining a detection result generated by a Solder Paste Inspection (SPI) device detecting the pad, the detection result includes a detection image corresponding to the solder joint with poor soldering;
analyzing the detection image corresponding to the solder joint with poor soldering by using the detection model, and generating an analysis result; and
displaying the detection image when the analysis result indicates that a bridge is contained in the detection image.

2. The method for detecting whether solder joints are bridged using a deep learning model according to claim 1, wherein building the detection model comprises: training a deep learning algorithm by using a plurality of images with and without bridges to generate the detection model.

3. The method for detecting whether solder joints are bridged using a deep learning model according to claim 1, wherein obtaining the detection result generated by the SPI device for detecting the pad comprises: continuously monitoring a target directory; when a file recording the detection result is added to the target directory, reading the detection result from the file.

4. The method for detecting whether solder joints are bridged using a deep learning model according to claim 1, further comprising: setting confirmation data corresponding to the detection image, and training the detection model using the confirmation data and the detection image.

5. The method for detecting whether solder joints are bridged using a deep learning model according to claim 1, further comprising: outputting corresponding position information when the analysis result indicates that a bridge is contained in the detection image.

6. A system for detecting whether solder joints are bridged using a deep learning model, comprising at least:
a model building module for building a detection model;
a result obtaining module for obtaining a detection result generated by an SPI device for detecting a pad, the pad includes a plurality of solder joints, and the detection result includes a detection image corresponding to the solder joint indicating poor soldering;
an image analysis module for analyzing the detection image corresponding to the solder joint with poor soldering by using the detection model, and generating an analysis result; and
an output module for displaying the detection image when the analysis result indicates that a bridge is contained in the detection image.

7. The system for detecting whether solder joints are bridged using a deep learning model according to claim 6, wherein the model building module trains a deep learning algorithm by using a plurality of images with and without bridges to generate the detection model.

8. The system for detecting whether solder joints are bridged using a deep learning model according to claim 6, wherein the result obtaining module continuously monitors a target directory; when a file recording the detection result is added to the target directory, the result obtaining module reads the detection result from the file.

9. The system for detecting whether solder joints are bridged using a deep learning model according to claim 6, further comprising a setting module to set confirmation data corresponding to the detection image, and the model building module further trains the detection model using the confirmation data and the detection image.

10. The system for detecting whether solder joints are bridged using a deep learning model according to claim 6, wherein the output module further outputs corresponding position information.
